(19) United States
(12) Patent Application Publication
(10) Pub. No.: US 2020/0365153 A1
(43) Pub. Date: Nov. 19, 2020

(54) VOICE-INTEGRATED AGRICULTURAL SYSTEM

(71) Applicant: The Climate Corporation, San Francisco, CA (US)

(72) Inventors: Mario Aquino, San Francisco, CA (US); Robert Grailer, San Francisco, CA (US); Tim Palmer, San Francisco, CA (US); Eric Turcotte, San Francisco, CA (US); Jeff Melching, San Francisco, CA (US)

(21) Appl. No.: 16/875,867

(22) Filed: May 15, 2020

Related U.S. Application Data
(60) Provisional application No. 62/849,589, filed on May 17, 2019.

(51) Int. Cl. G10L 15/22; G10L 15/26; G06F 3/16; G06F 3/0481; G06F 16/432; G06Q 50/02

(52) U.S. Cl. CPC G10L 15/22; G10L 15/265; G06F 3/167; G10L 2015/223; G06F 16/433; G06Q 50/02; G06F 3/04817

(57) ABSTRACT

In some embodiments, a system and a computer-implemented method for integrating voice-based interface in agricultural systems are disclosed. A method comprises: receiving speech data of a spoken voice command comprising a request for agricultural information; transmitting the speech data to a voice service provider to transform the speech data to a sequence of request text strings; receiving the sequence of request text strings comprising an intent string that indicates a category of the spoken voice command; based on the sequence of request text strings, generating queries for obtaining result sets of agricultural data relevant to the category of the spoken voice command; transmitting the queries to agricultural data repositories; receiving the result sets of agricultural data; based on the result sets, generating control signals for modifying controls implemented in an agricultural machine; transmitting the control signals to the agricultural machine to control agricultural tasks performed by the agricultural machine.

### BENEFIT CLAIM

This application claims the benefit under 35 U.S.C. § 119(e) of provisional application 62/849,589, filed May 17, 2019, the entire contents of which is hereby incorporated by reference for all purposes as if fully set forth herein. The applicants hereby rescind any disclaimer of claim scope in the parent applications or the prosecution history thereof and advise the USPTO that the claims in this application may be broader than any claim in the parent applications.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2015-2020 The Climate Corporation.

### FIELD OF THE DISCLOSURE

One technical field of the present disclosure relates to voice control of an agricultural computer system that provides agricultural information about agronomic fields. Another technical field is controlling and manipulating agricultural equipment for agricultural management through a voice-driven interface.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Agricultural equipment may be controlled using a touch-screen user interface of a compact computer that is located in a cab or other operating location of the equipment. However, using the touch-screen interface of agricultural environment can be inconvenient and cumbersome. For example, interacting with the touch-screen while driving a tractor along a bumpy road and at inadequate lighting conditions may be inconvenient and challenging. Furthermore, if a driver of the tractor wears gloves or protective gear, providing manual input to the touch-screen of the interface is simply unworkable. The touch-screen may be small and hard to read, so using the touch-screen to control agronomic machinery in the agricultural environment may be difficult and impractical.

### SUMMARY

The appended claims may serve as a summary of the disclosure.

### BRIEF DESCRIPTION OF THE DRAWINGS

In the drawings:

FIG. 1A is an example computer system configured to perform the functions described herein, shown in a field environment with other apparatus with which the system may interoperate.

FIG. 1B is an example voice controller service.

FIG. 2A shows a view of an example logical organization of sets of instructions in main memory when an example mobile application is loaded for execution.

FIG. 2B shows a view of an example logical organization of sets of instructions in main memory when an example mobile application is loaded for execution.

FIG. 3 shows a programmed process by which the agricultural intelligence computer system generates one or more preconfigured agronomic models using agronomic data provided by one or more data sources.

FIG. 4 is a block diagram that shows a computer system upon which some embodiments of the invention may be implemented.

FIG. 5 shows an example embodiment of a timeline view for data entry.

FIG. 6 shows an example embodiment of a spreadsheet view for data entry.

FIG. 7A shows an example computer system that is programmed to process voice commands for use with agricultural applications.

FIG. 7B shows an example computer-implemented process for manipulating a voice-integrated agricultural intelligence computer system through a voice interface.

FIG. 8A shows an example voice command.

FIG. 8B shows an embodiment for processing an example voice command and represents a fully-worked example of the foregoing disclosure.

### DETAILED DESCRIPTION

In the following description, for the purposes of explanation, numerous specific details are set forth in order to provide a thorough understanding of the present disclosure. It will be apparent, however, that embodiments may be practiced without these specific details. In other instances, well-known structures and devices are shown in block diagram form in order to avoid unnecessarily obscuring the present disclosure. Embodiments are disclosed in sections according to the following outline:

1. GENERAL OVERVIEW

2. EXAMPLE AGRICULTURAL INTELLIGENCE COMPUTER SYSTEM
2.1. STRUCTURAL OVERVIEW
2.2. APPLICATION PROGRAM OVERVIEW
2.3. DATA INGEST TO THE COMPUTER SYSTEM
2.4. PROCESS OVERVIEW-AGRONOMIC MODEL TRAINING
2.5. IMPLEMENTATION EXAMPLE-HARDWARE OVERVIEW

3. STRUCTURAL AND FUNCTIONAL DESCRIPTION
3.1. OVERVIEW OF EXAMPLE VOICE PROCESSING SYSTEM
3.2. INTENT EXAMPLES
3.3. SETS OF KNOWN INTENTS

4. EXAMPLE VOICE COMMANDS

5. EXAMPLE IMPLEMENTATION METHODS

6. IMPROVEMENTS PROVIDED BY CERTAIN EMBODIMENTS

### 1. General Overview

In some embodiments, voice-integrated computer systems, computer programs and data processing methods that provide improvements in controlling agricultural equipment, devices and software through the use of a voice interface are described. The voice interface is also referred to as a conversational user interface or an audio user interface. Certain embodiments are programmed to support manipulating visual content displayed on the interface or actions taken by agricultural machinery.

Information for controlling agricultural equipment using a voice-integrated agricultural system may be gathered through an audio user interface allowing a grower or user to audibly interact with the system. Embodiments are useful to provide foreign language explanation of features, generate control signals for controlling agricultural equipment, provide data entry to the system, and obtain clarification and details about agricultural equipment through voice.

Other applications may include voice-controlled creation of field notes or scouting notes, receiving spoken alerts relating to operations of agricultural equipment such as improper ground contact or seeding blockage, and audibly submitting general questions about the state of public or private agronomic data. Using a voice interface, growers may improve prioritization of agricultural tasks performed by the growers and improve the way they cultivate the fields. For example, the growers can rapidly and efficiently provide audible queries and receive audible responses containing information pertaining to the fields. The information may include indications of the fields that have nutrients deficiencies or need to be inspected. The information may also include indications of expected yield outcomes, weather notifications or planting information. Contextual search queries may also be supported.

In some embodiments, a voice command is captured by a computing device equipped with a microphone. The voice command typically starts with a wake word, or a combination of a wake word and an invocation. The wake word may be signaled by tapping a button in a graphical user interface of a mobile computing device and then issuing a wake phrase. An example wake phrase is “OK FIELD VOICE” or “FIELD VOICE.” Alternatively, a button with a microphone icon may be displayed in a user interface and tapping the icon may initiate recording of the voice command.

A voice command captured by a microphone may be associated with an intent. An intent may indicate a classification of the voice command. The intent may represent, for example, a keyword that may be used to classify the voice command. The voice command may also include one or more parameter values of the parameters that may be later used to determine a response to the voice command. The voice command received via a microphone may be digitized and transformed to a digitized voice command. The digitized voice command may be transmitted or forwarded to a back-end voice service provider for a speech-to-text transformation.

A voice service provider may be configured to parse the digitized voice command into a set of text strings and compare the text strings to a set of known intents. Based on the comparison, the voice service provider may identify the intent in the text strings, and, optionally, one or more parameter values. The set of text strings may be transmitted to a voice-integration computing device.

Upon receiving the set of text strings, the voice-integration computing device may generate one or more queries specific to the intent and the parameter values. The queries may be generated using intent-specific pre-defined templates and may be sent to data repository services for providing answers to the queries.

Based on the received answers, the computing device may generate a set of response text strings. The set of response text strings may include an output statement containing an answer to the voice command. The output statement may be transmitted to the voice service provider to perform a text-to-speech transformation. The voice service provider may convert the output statement into audio data and send the converted audio data to the computing device.

In some embodiments, an intent is processed to generate code or instructions and the code and instructions are transmitted to an originating device. The instructions may be received and broadcast to other processes for execution. The instructions may allow to navigate to other screens or applications generated by the user interface, launch applications for generating graphical representations of screens of the user interface, facilitate entering data into the user interface, and generate control signals for controlling agriculture equipment and machinery.

The voice-integrated system helps users to interact with an agricultural intelligence computer system to request and obtain agriculture-related information. The voice-integrated system provides voice capabilities that allow the user to increase the level of user engagement in the agricultural activities and field cultivation. The voice-integrated system may improve the efficiency of controlling agricultural devices and help the users to retrieve field information with minimal interaction with computerized data repositories and devices.

### 2. Example Agricultural Intelligence Computer System

### 2.1. Structural Overview

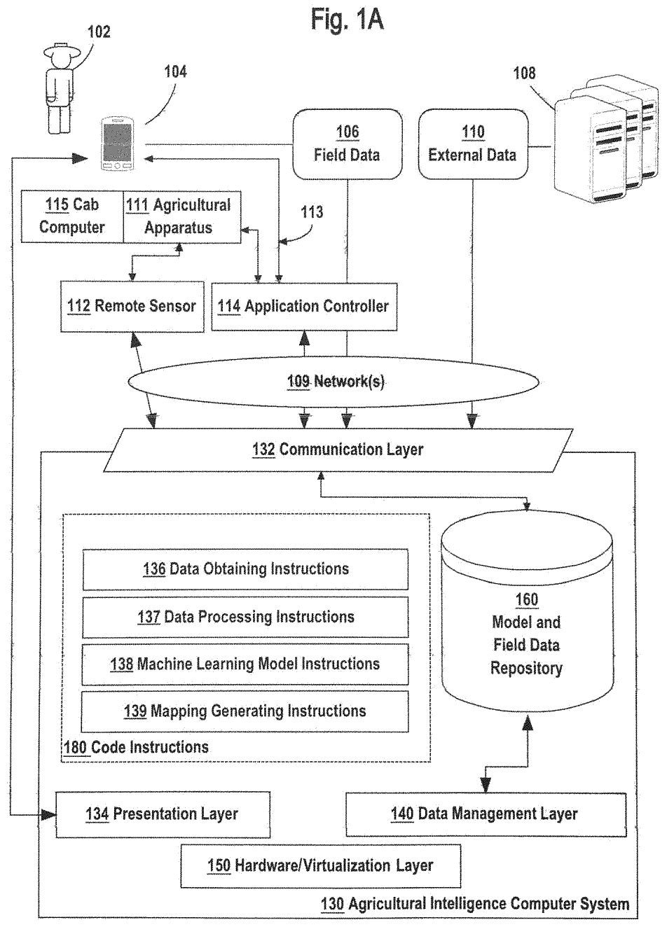

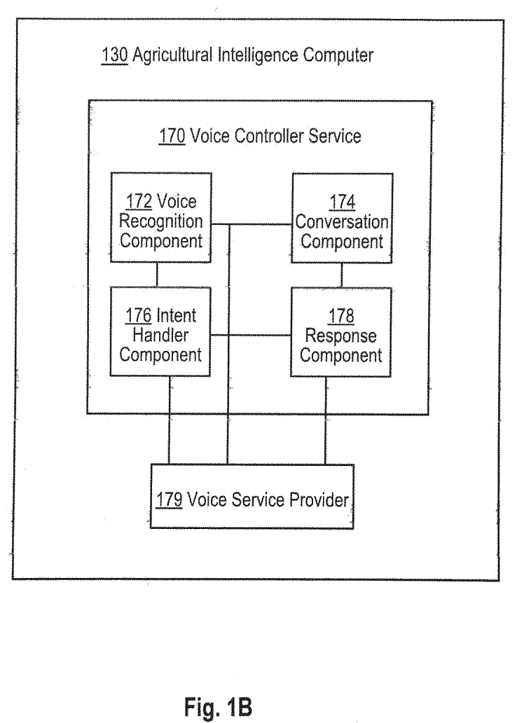

FIG. 1A is an example computer system configured to perform the functions described herein, shown in a field environment with other apparatus with which the system may interoperate. In one embodiment, a user 102 owns, operates or possesses a field manager computing device 104 in a field location or associated with a field location such as a field intended for agricultural activities or a management location for one or more agricultural fields. The field manager computer device 104 is programmed or configured to provide field data 106 to an agricultural intelligence computer system 130 via one or more networks 109.

Examples of field data 106 include (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) chemical application data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), and (k) soil, seed, crop phenology, pest and disease reporting, and predictions sources and databases.

A data server computer 108 is communicatively coupled to agricultural intelligence computer system 130 and is programmed or configured to send external data 110 to agricultural intelligence computer system 130 via the network(s) 109. The external data server computer 108 may be owned or operated by the same legal person or entity as the agricultural intelligence computer system 130, or by a different person or entity such as a government agency, non-governmental organization (NGO), and/or a private data service provider. Examples of external data include weather data, imagery data, soil data, or statistical data relating to crop yields, among others. External data 110 may consist of the same type of information as field data 106. In some embodiments, the external data 110 is provided by an external data server 108 owned by the same entity that owns and/or operates the agricultural intelligence computer system 130. For example, the agricultural intelligence computer system 130 may include a data server focused exclusively on a type of data that might otherwise be obtained from third party sources, such as weather data. In some embodiments, an external data server 108 may actually be incorporated within the system 130.

An agricultural apparatus 111 may have one or more remote sensors 112 fixed thereon, which sensors are communicatively coupled either directly or indirectly via agricultural apparatus 111 to the agricultural intelligence computer system 130 and are programmed or configured to send sensor data to agricultural intelligence computer system 130. Examples of agricultural apparatus 111 include tractors, combines, harvesters, planters, trucks, fertilizer equipment, aerial vehicles including unmanned aerial vehicles, and any other item of physical machinery or hardware, typically mobile machinery, and which may be used in tasks associated with agriculture. In some embodiments, a single unit of apparatus 111 may comprise a plurality of sensors 112 that are coupled locally in a network on the apparatus; controller area network (CAN) is example of such a network that can be installed in combines, harvesters, sprayers, and cultivators. Application controller 114 is communicatively coupled to agricultural intelligence computer system 130 via the network(s) 109 and is programmed or configured to receive one or more scripts that are used to control an operating parameter of an agricultural vehicle or implement from the agricultural intelligence computer system 130. For instance, a controller area network (CAN) bus interface may be used to enable communications from the agricultural intelligence computer system 130 to the agricultural apparatus 111, such as how the CLIMATE FIELDVIEW DRIVE, available from The Climate Corporation, San Francisco, Calif., is used. Sensor data may consist of the same type of information as field data 106. In some embodiments, remote sensors 112 may not be fixed to an agricultural apparatus 111 but may be remotely located in the field and may communicate with network 109.

The apparatus 111 may comprise a cab computer 115 that is programmed with a cab application, which may comprise a version or variant of the mobile application for device 104 that is further described in other sections herein. In some embodiments, cab computer 115 comprises a compact computer, often a tablet-sized computer or smartphone, with a graphical screen display, such as a color display, that is mounted within an operator's cab of the apparatus 111. Cab computer 115 may implement some or all of the operations and functions that are described further herein for the mobile computer device 104.

The network(s) 109 broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1A. The various elements of FIG. 1A may also have direct (wired or wireless) communications links. The sensors 112, controller 114, external data server computer 108, and other elements of the system each comprise an interface compatible with the network(s) 109 and are programmed or configured to use standardized protocols for communication across the networks such as TCP/IP, Bluetooth, CAN protocol and higher-layer protocols such as HTTP, TLS, and the like.

Agricultural intelligence computer system 130 is programmed or configured to receive field data 106 from field manager computing device 104, external data 110 from external data server computer 108, and sensor data from remote sensor 112. Agricultural intelligence computer system 130 may be further configured to host, use or execute one or more computer programs, other software elements, digitally programmed logic such as FPGAs or ASICs, or any combination thereof to perform translation and storage of data values, construction of digital models of one or more crops on one or more fields, generation of recommendations and notifications, and generation and sending of scripts to application controller 114, in the manner described further in other sections of this disclosure.

In some embodiments, agricultural intelligence computer system 130 is programmed with or comprises a communication layer 132, presentation layer 134, data management layer 140, hardware/virtualization layer 150, model and field data repository 160, intent repository 162, voice controller service 170 and code instructions 180. “Layer,” in this context, refers to any combination of electronic digital interface circuits, microcontrollers, firmware such as drivers, and/or computer programs or other software elements.

In an embodiment, code instructions 180 comprise data obtaining instructions 136, data processing instructions 137, machine learning model instructions 138, and mapping generating instructions 139. Additional code instructions may be also included. Data obtaining instructions 136 may be used to obtain data for creating, storing, cataloging and browsing model and field data repository 160. Data processing 137 may be used to facilitate audio-to-text conversions, text-to-audio conversions, intent determination, and the like. Machine learning model instructions 138 may be used to determine execution requirements for machine-based models, manage execution resources available in a model execution infrastructure platform, and manage execution of the models in the model execution infrastructure platform. Mapping generating instructions 139 may be used to receive, process, map data and provide the data to proper platforms.

Communication layer 132 may be programmed or configured to perform input/output interfacing functions including sending requests to field manager computing device 104, external data server computer 108, and remote sensor 112 for field data, external data, and sensor data respectively. Communication layer 132 may be programmed or configured to send the received data to model and field data repository 160 to be stored as field data 106.

Presentation layer 134 may be programmed or configured to generate a graphical user interface (GUI) to be displayed on field manager computing device 104, cab computer 115 or other computers that are coupled to the system 130 through the network 109. The GUI may comprise controls for inputting data to be sent to agricultural intelligence computer system 130, generating requests for models and/or recommendations, and/or displaying recommendations, notifications, models, and other field data.

Data management layer 140 may be programmed or configured to manage read operations and write operations involving the repository 160 and other functional elements of the system, including queries and result sets communicated between the functional elements of the system and the repository. Examples of data management layer 140 include JDBC, SQL server interface code, and/or HADOOP interface code, among others. Repository 160 may comprise a database. As used herein, the term “database” may refer to either a body of data, a relational database management system (RDBMS), or to both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases. However, any database may be used that enables the systems and methods described herein.

When field data 106 is not provided directly to the agricultural intelligence computer system via one or more agricultural machines or agricultural machine devices that interacts with the agricultural intelligence computer system, the user may be prompted via one or more user interfaces on the user device (served by the agricultural intelligence computer system) to input such information. In an example embodiment, the user may specify identification data by accessing a map on the user device (served by the agricultural intelligence computer system) and selecting specific CLUs that have been graphically shown on the map. In an alternative embodiment, the user 102 may specify identification data by accessing a map on the user device (served by the agricultural intelligence computer system 130) and drawing boundaries of the field over the map. Such CLU selection or map drawings represent geographic identifiers. In alternative embodiments, the user may specify identification data by accessing field identification data (provided as shape files or in a similar format) from the U. S. Department of Agriculture Farm Service Agency or other source via the user device and providing such field identification data to the agricultural intelligence computer system.

In an example embodiment, the agricultural intelligence computer system 130 is programmed to generate and cause displaying a graphical user interface comprising a data manager for data input. After one or more fields have been identified using the methods described above, the data manager may provide one or more graphical user interface widgets which when selected can identify changes to the field, soil, crops, tillage, or nutrient practices. The data manager may include a timeline view, a spreadsheet view, and/or one or more editable programs.

FIG. 1B is an example voice controller service 170. In some embodiments, voice controller service 170 is part of agricultural intelligence computer system 130. Alternatively, a voice controller service is implemented separately from agricultural computer system 130. Voice controller service 170 may include a voice recognition component 172, a conversation component 174, an intent handler component 176, and a response component 178. Voice recognition component 172 may be programmed to receive a voice command from a user device. The voice command may be associated with one or more intents phrased in a form of a question, a statement, or a command that is intended by the user. A set of intents may be defined by agricultural intelligence computer system 130 and stored in repository 160.

In some embodiments, the intents can be defined by keywords included in voice commands and may be stored in repository 160. Repository 160 may include various permutations of intents that can be used to request specific field information.

Voice recognition component 172 may be programmed to initiate a speech recognition process by receiving an input triggering a voice recording process. The voice command can be captured using a recording component connected to field manager computing device 104 or cab computer 115 (both shown in FIG. 1A). Voice recognition component 172 may be configured to capture a voice command issued by a user and send the recording of the command to a voice service provider 179 that uses a natural language processing model to recognize an intent and parameters included in the voice command.

Conversation component 174 may be programmed to create a session that collects recognized command and records the context of voice interaction. If the voice command requires an additional parameter, conversation component 174 may initiate a feedback loop to request missing information from a user. Conversation component 174 may maintain the session until a sufficient parameter or context is collected to process the voice command.

Intent handler component 176 may be programmed to query field information specific to the parameter based on the recognized intent. Intent handler component 176 may send a request to a relevant service within agricultural intelligence computer system 130 to retrieve field information from model and repository 160 (shown in FIG. 1A). Intent handler component 176 may send several requests to relevant data repositories to build enough context needed to generate a response.

Response component 178 may be programmed to generate a response based on the retrieved information from repository 160 (shown in FIG. 1A). A response can be structured in a way to sound natural to the user. Each response may be structured based on an intent-specific format. The response may be sent to voice service provider 179 for text-to-speech transformation. After voice service provider 179 performs the text-to-speech transformation, the response is returned to voice controller service 172 as audio data to be played at field manager computing device 104 or cab computer 115 (shown in FIG. 1A). In some embodiments, the response can be a request that contains structured information that controls the software or the hardware on the field manager computing device 104, cab computer 115, or agricultural apparatus 111 (shown in FIG. 1A).

In some embodiments, the text-to-speech capability may be used to audibly play the contents or explain functional features with a greater clarity, thus providing practical assistance to field staff who could be illiterate or not a speaker of the language in which the screen is displayed. In some embodiments, text-to-speech conversion facilitated by the system herein could implement a voice feature that could describe the screens and buttons that are being pressed as well as alert the operator about the key events as they occur. For example, such voice assistance could be enabled to support the experience of first-time users who are unfamiliar with navigating screens.

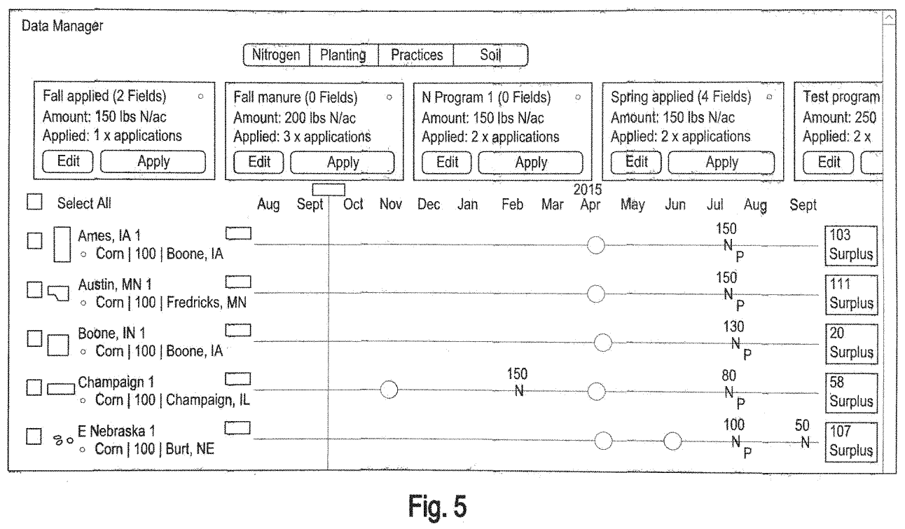

FIG. 5 shows an example embodiment of a timeline view for data entry. Using the display depicted in FIG. 5, a user computer can input a selection of a particular field and a particular date for the addition of event. Events depicted at the top of the timeline may include Nitrogen, Planting, Practices, and Soil. To add a nitrogen application event, a user computer may provide input to select the nitrogen tab. The user computer may then select a location on the timeline for a particular field in order to indicate an application of nitrogen on the selected field. In response to receiving a selection of a location on the timeline for a particular field, the data manager may display a data entry overlay, allowing the user computer to input data pertaining to nitrogen applications, planting procedures, soil application, tillage procedures, irrigation practices, or other information relating to the particular field. For example, if a user computer selects a portion of the timeline and indicates an application of nitrogen, then the data entry overlay may include fields for inputting an amount of nitrogen applied, a date of application, a type of fertilizer used, and any other information related to the application of nitrogen.

In some embodiments, the data manager provides an interface for creating one or more programs. “Program,” in this context, refers to a set of data pertaining to nitrogen applications, planting procedures, soil application, tillage procedures, irrigation practices, or other information that may be related to one or more fields, and that can be stored in digital data storage for reuse as a set in other operations. After a program has been created, it may be conceptually applied to one or more fields and references to the program may be stored in digital storage in association with data identifying the fields. Thus, instead of manually entering identical data relating to the same nitrogen applications for multiple different fields, a user computer may create a program that indicates a particular application of nitrogen and then apply the program to multiple different fields. For example, in the timeline view of FIG. 5, the top two timelines have the “Spring applied” program selected, which includes an application of 150 lbs. N/ac in early April. The data manager may provide an interface for editing a program.

In some embodiments, when a particular program is edited, each field that has selected the particular program is edited. For example, in FIG. 5, if the “Spring applied” program is edited to reduce the application of nitrogen to 130 lbs. N/ac, the top two fields may be updated with a reduced application of nitrogen based on the edited program.

In some embodiments, in response to receiving edits to a field that has a program selected, the data manager removes the correspondence of the field to the selected program. For example, if a nitrogen application is added to the top field in FIG. 5, the interface may update to indicate that the “Spring applied” program is no longer being applied to the top field. While the nitrogen application in early April may remain, updates to the “Spring applied” program would not alter the April application of nitrogen.

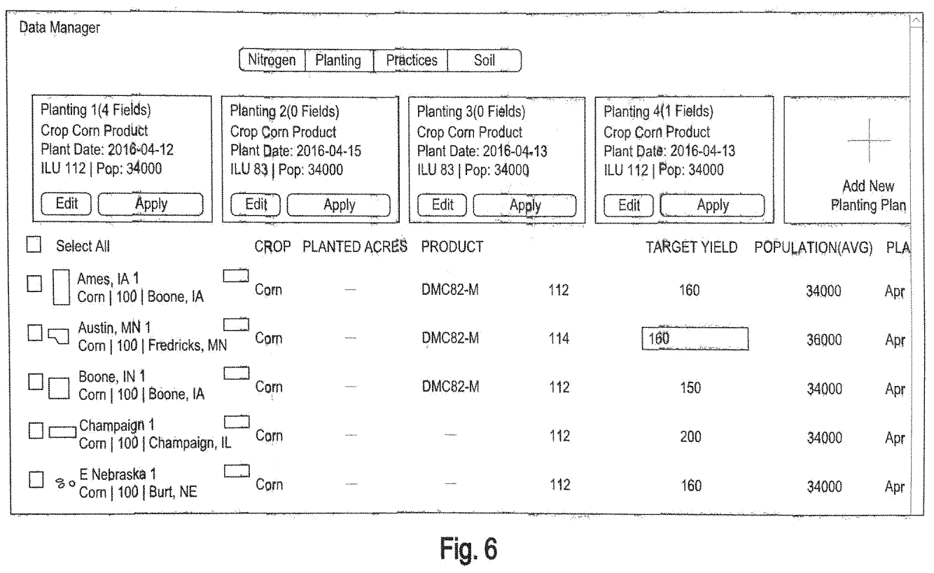

FIG. 6 shows an example embodiment of a spreadsheet view for data entry. Using the display depicted in FIG. 6, a user can create and edit information for one or more fields. The data manager may include spreadsheets for inputting information with respect to Nitrogen, Planting, Practices, and Soil as depicted in FIG. 6. To edit a particular entry, a user computer may select the particular entry in the spreadsheet and update the values. For example, FIG. 6 depicts an in-progress update to a target yield value for the second field. Additionally, a user computer may select one or more fields in order to apply one or more programs. In response to receiving a selection of a program for a particular field, the data manager may automatically complete the entries for the particular field based on the selected program. As with the timeline view, the data manager may update the entries for each field associated with a particular program in response to receiving an update to the program. Additionally, the data manager may remove the correspondence of the selected program to the field in response to receiving an edit to one of the entries for the field.

In some embodiments, model and field data is stored in model and field data repository 160. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data.

In some embodiments, field data repository 160 includes one or more sub-data repositories that are categorized based on a type of intent. Each sub-repository can include specific field data corresponding to the classified type of intent. An intent is a particular keyword that classifies a voice command. For example, a “nitrogen” intent repository can include nitrogen data on the field. In another example, an “imagery” intent repository can include satellite images of the field. When a voice command is received at agricultural intelligence computer system 130, the voice command is analyzed based on the type of intent and a corresponding repository is queried into to retrieve relevant field information.

Intent repository 162 includes a set of intents that is defined by computer system 130. The intent repository can include various permutations of intents that can be analyzed as audio input to voice controller service 170. The set of intents stored in intent repository can be updated as intent component 184 updates the set of intents.

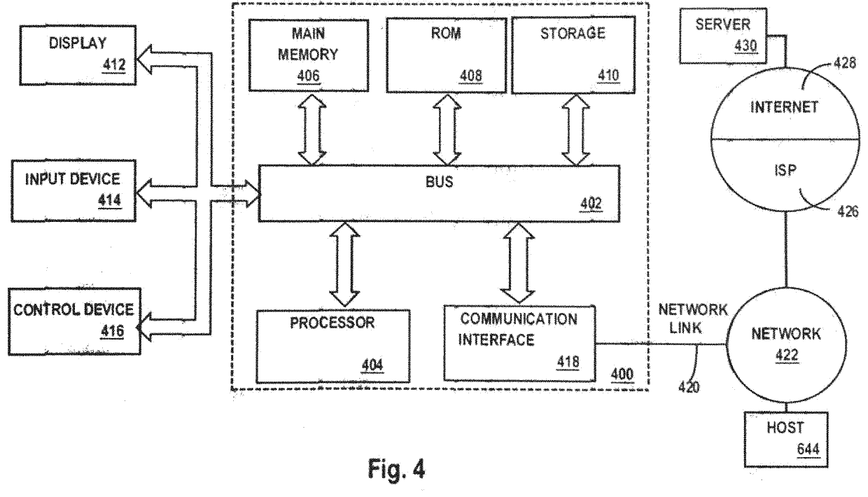

Hardware/virtualization layer 150 comprises one or more central processing units (CPUs), memory controllers, and other devices, components, or elements of a computer system such as volatile or non-volatile memory, non-volatile storage such as disk, and I/O devices or interfaces as illustrated and described, for example, in connection with FIG. 4. The layer 150 also may comprise programmed instructions that are configured to support virtualization, containerization, or other technologies.

For purposes of illustrating a clear example, FIG. 1A shows a limited number of instances of certain functional elements. However, in other embodiments, there may be any number of such elements. For example, embodiments may use thousands or millions of different mobile computing devices 104 associated with different users. Further, the system 130 and/or external data server computer 108 may be implemented using two or more processors, cores, clusters, or instances of physical machines or virtual machines, configured in a discrete location or co-located with other elements in a datacenter, shared computing facility or cloud computing facility.

### 2.2. Application Program Overview

In some embodiments, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for inventions and disclosures of this type.

In some embodiments, user 102 interacts with agricultural intelligence computer system 130 using field manager computing device 104 configured with an operating system and one or more application programs or apps; the field manager computing device 104 also may interoperate with the agricultural intelligence computer system independently and automatically under program control or logical control and direct user interaction is not always required. Field manager computing device 104 broadly represents one or more of a smart phone, PDA, tablet computing device, laptop computer, desktop computer, workstation, or any other computing device capable of transmitting and receiving information and performing the functions described herein. Field manager computing device 104 may communicate via a network using a mobile application stored on field manager computing device 104, and in some embodiments, the device may be coupled using a cable 113 or connector to the sensor 112 and/or controller 114. A particular user 102 may own, operate or possess and use, in connection with system 130, more than one field manager computing device 104 at a time.

The mobile application may provide client-side functionality, via the network to one or more mobile computing devices. In an example embodiment, field manager computing device 104 may access the mobile application via a web browser or a local client application or app. Field manager computing device 104 may transmit data to, and receive data from, one or more front-end servers, using web-based protocols or formats such as HTTP, XML and/or JSON, or app-specific protocols. In an example embodiment, the data may take the form of requests and user information input, such as field data, into the mobile computing device. In some embodiments, the mobile application interacts with location tracking hardware and software on field manager computing device 104 which determines the location of field manager computing device 104 using standard tracking techniques such as multilateration of radio signals, the global positioning system (GPS), Wi-Fi positioning systems, or other methods of mobile positioning. In some cases, location data or other data associated with the device 104, user 102, and/or user account(s) may be obtained by queries to an operating system of the device or by requesting an app on the device to obtain data from the operating system.

In some embodiments, field manager computing device 104 sends field data 106 to agricultural intelligence computer system 130 comprising or including, but not limited to, data values representing one or more of: a geographical location of the one or more fields, tillage information for the one or more fields, crops planted in the one or more fields, and soil data extracted from the one or more fields. Field manager computing device 104 may send field data 106 in response to user input from user 102 specifying the data values for the one or more fields. Additionally, field manager computing device 104 may automatically send field data 106 when one or more of the data values becomes available to field manager computing device 104. For example, field manager computing device 104 may be communicatively coupled to remote sensor 112 and/or application controller 114 which include an irrigation sensor and/or irrigation controller. In response to receiving data indicating that application controller 114 released water onto the one or more fields, field manager computing device 104 may send field data 106 to agricultural intelligence computer system 130 indicating that water was released on the one or more fields. Field data 106 identified in this disclosure may be input and communicated using electronic digital data that is communicated between computing devices using parameterized URLs over HTTP, or another suitable communication or messaging protocol.

A commercial example of the mobile application is CLIMATE FIELDVIEW, commercially available from The Climate Corporation, San Francisco, Calif. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

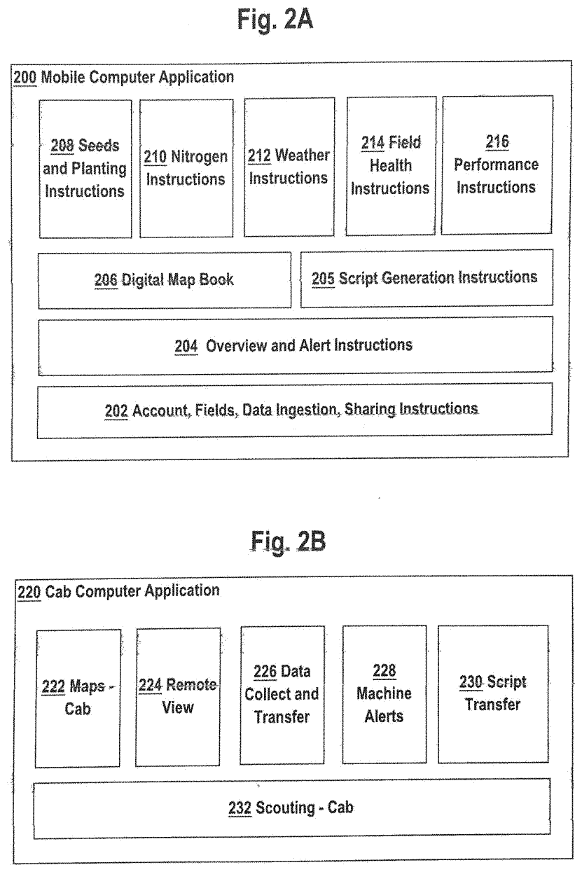

FIG. 2A shows a view of an example logical organization of sets of instructions in main memory when an example mobile application is loaded for execution. In FIG. 2A, each named element represents a region of one or more pages of RAM or other main memory, or one or more blocks of disk storage or other non-volatile storage, and the programmed instructions within those regions. In one embodiment, in view (a), a mobile computer application 200 comprises account-fields-data ingestion-sharing instructions 202, overview and alert instructions 204, digital map book instructions 206, seeds and planting instructions 208, nitrogen instructions 210, weather instructions 212, field health instructions 214, and performance instructions 216.

In one embodiment, a mobile computer application 200 comprises account, fields, data ingestion, sharing instructions 202 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 200 comprises a data inbox. In response to receiving a selection of the data inbox, the mobile computer application 200 may display a graphical user interface for manually uploading data files and importing uploaded files to a data manager.

In one embodiment, digital map book instructions 206 comprise field map data layers stored in device memory and are programmed with data visualization tools and geospatial field notes. This provides growers with convenient information close at hand for reference, logging and visual insights into field performance. In one embodiment, overview and alert instructions 204 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 208 are programmed to provide tools for seed selection, hybrid placement, and script creation, including variable rate (VR) script creation, based upon scientific models and empirical data. This enables growers to maximize yield or return on investment through optimized seed purchase, placement and population.

In one embodiment, script generation instructions 205 are programmed to provide an interface for generating scripts, including variable rate (VR) fertility scripts. The interface enables growers to create scripts for field implements, such as nutrient applications, planting, and irrigation. For example, a planting script interface may comprise tools for identifying a type of seed for planting. Upon receiving a selection of the seed type, mobile computer application 200 may display one or more fields broken into management zones, such as the field map data layers created as part of digital map book instructions 206. In one embodiment, the management zones comprise soil zones along with a panel identifying each soil zone and a soil name, texture, drainage for each zone, or other field data. Mobile computer application 200 may also display tools for editing or creating such, such as graphical tools for drawing management zones, such as soil zones, over a map of one or more fields. Planting procedures may be applied to all management zones or different planting procedures may be applied to different subsets of management zones. When a script is created, mobile computer application 200 may make the script available for download in a format readable by an application controller, such as an archived or compressed format. Additionally, and/or alternatively, a script may be sent directly to cab computer 115 from mobile computer application 200 and/or uploaded to one or more data servers and stored for further use.

In one embodiment, nitrogen instructions 210 are programmed to provide tools to inform nitrogen decisions by visualizing the availability of nitrogen to crops. This enables growers to maximize yield or return on investment through optimized nitrogen application during the season. Example programmed functions include displaying images such as SSURGO images to enable drawing of fertilizer application zones and/or images generated from subfield soil data, such as data obtained from sensors, at a high spatial resolution (as fine as millimeters or smaller depending on sensor proximity and resolution); upload of existing grower-defined zones; providing a graph of plant nutrient availability and/or a map to enable tuning application(s) of nitrogen across multiple zones; output of scripts to drive machinery; tools for mass data entry and adjustment; and/or maps for data visualization, among others. “Mass data entry,” in this context, may mean entering data once and then applying the same data to multiple fields and/or zones that have been defined in the system; example data may include nitrogen application data that is the same for many fields and/or zones of the same grower, but such mass data entry applies to the entry of any type of field data into the mobile computer application 200. For example, nitrogen instructions 210 may be programmed to accept definitions of nitrogen application and practices programs and to accept user input specifying to apply those programs across multiple fields. “Nitrogen application programs,” in this context, refers to stored, named sets of data that associates: a name, color code or other identifier, one or more dates of application, types of material or product for each of the dates and amounts, method of application or incorporation such as injected or broadcast, and/or amounts or rates of application for each of the dates, crop or hybrid that is the subject of the application, among others. “Nitrogen practices programs,” in this context, refer to stored, named sets of data that associates: a practices name; a previous crop; a tillage system; a date of primarily tillage; one or more previous tillage systems that were used; one or more indicators of application type, such as manure, that were used. Nitrogen instructions 210 also may be programmed to generate and cause displaying a nitrogen graph, which indicates projections of plant use of the specified nitrogen and whether a surplus or shortfall is predicted; in some embodiments, different color indicators may signal a magnitude of surplus or magnitude of shortfall. In one embodiment, a nitrogen graph comprises a graphical display in a computer display device comprising a plurality of rows, each row associated with and identifying a field; data specifying what crop is planted in the field, the field size, the field location, and a graphic representation of the field perimeter; in each row, a timeline by month with graphic indicators specifying each nitrogen application and amount at points correlated to month names; and numeric and/or colored indicators of surplus or shortfall, in which color indicates magnitude.

In one embodiment, the nitrogen graph may include one or more user input features, such as dials or slider bars, to dynamically change the nitrogen planting and practices programs so that a user may optimize his nitrogen graph. The user may then use his optimized nitrogen graph and the related nitrogen planting and practices programs to implement one or more scripts, including variable rate (VR) fertility scripts. Nitrogen instructions 210 also may be programmed to generate and cause displaying a nitrogen map, which indicates projections of plant use of the specified nitrogen and whether a surplus or shortfall is predicted; in some embodiments, different color indicators may signal a magnitude of surplus or magnitude of shortfall. The nitrogen map may display projections of plant use of the specified nitrogen and whether a surplus or shortfall is predicted for different times in the past and the future (such as daily, weekly, monthly or yearly) using numeric and/or colored indicators of surplus or shortfall, in which color indicates magnitude. In one embodiment, the nitrogen map may include one or more user input features, such as dials or slider bars, to dynamically change the nitrogen planting and practices programs so that a user may optimize his nitrogen map, such as to obtain a preferred amount of surplus to shortfall. The user may then use his optimized nitrogen map and the related nitrogen planting and practices programs to implement one or more scripts, including variable rate (VR) fertility scripts. In other embodiments, similar instructions to the nitrogen instructions 210 could be used for application of other nutrients (such as phosphorus and potassium), application of pesticide, and irrigation programs.

In one embodiment, weather instructions 212 are programmed to provide field-specific recent weather data and forecasted weather information. This enables growers to save time and have an efficient integrated display with respect to daily operational decisions.

In one embodiment, field health instructions 214 are programmed to provide timely remote sensing images highlighting in-season crop variation and potential concerns. Example programmed functions include cloud checking, to identify possible clouds or cloud shadows; determining nitrogen indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 216 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 216 may be programmed to communicate via the network(s) 109 to back-end analytics programs executed at agricultural intelligence computer system 130 and/or external data server computer 108 and configured to analyze metrics such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of cab computer 115.

FIG. 2B shows a view of an example logical organization of sets of instructions in main memory when an example mobile application is loaded for execution. In the depicted example, a cab computer application 220 may comprise maps-cab instructions 222, remote view instructions 224, data collect and transfer instructions 226, machine alerts instructions 228, script transfer instructions 230, and scouting-cab instructions 232. The code base for the instructions of view (b) may be the same as for view (a) and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 222 may be programmed to provide map views of fields, farms or regions that are useful in directing machine operation. The remote view instructions 224 may be programmed to turn on, manage, and provide views of machine activity in real-time or near real-time to other computing devices connected to the system 130 via wireless networks, wired connectors or adapters, and the like. The data collect and transfer instructions 226 may be programmed to turn on, manage, and provide transfer of data collected at sensors and controllers to the system 130 via wireless networks, wired connectors or adapters, and the like. The machine alerts instructions 228 may be programmed to detect issues with operations of the machine or tools that are associated with the cab and generate operator alerts. The script transfer instructions 230 may be configured to transfer in scripts of instructions that are configured to direct machine operations or the collection of data. The scouting-cab instructions 232 may be programmed to display location-based alerts and information received from the system 130 based on the location of the field manager computing device 104, agricultural apparatus 111, or sensors 112 in the field and ingest, manage, and provide transfer of location-based scouting observations to the system 130 based on the location of the agricultural apparatus 111 or sensors 112 in the field.

### 2.3. Data Ingest to the Computer System

In some embodiments, external data server computer 108 stores external data 110, including soil data representing soil composition for the one or more fields and weather data representing temperature and precipitation on the one or more fields. The weather data may include past and present weather data as well as forecasts for future weather data. In some embodiments, external data server computer 108 comprises a plurality of servers hosted by different entities. For example, a first server may contain soil composition data while a second server may include weather data. Additionally, soil composition data may be stored in multiple servers. For example, one server may store data representing percentage of sand, silt, and clay in the soil while a second server may store data representing percentage of organic matter (OM) in the soil.

In some embodiments, remote sensor 112 comprises one or more sensors that are programmed or configured to produce one or more observations. Remote sensor 112 may be aerial sensors, such as satellites, vehicle sensors, planting equipment sensors, tillage sensors, fertilizer or insecticide application sensors, harvester sensors, and any other implement capable of receiving data from the one or more fields. In some embodiments, application controller 114 is programmed or configured to receive instructions from agricultural intelligence computer system 130. Application controller 114 may also be programmed or configured to control an operating parameter of an agricultural vehicle or implement. For example, an application controller may be programmed or configured to control an operating parameter of a vehicle, such as a tractor, planting equipment, tillage equipment, fertilizer or insecticide equipment, harvester equipment, or other farm implements such as a water valve. Other embodiments may use any combination of sensors and controllers, of which the following are merely selected examples.

The system 130 may obtain or ingest data under user 102 control, on a mass basis from many growers who have contributed data to a shared database system. This form of obtaining data may be termed “manual data ingest” as one or more user-controlled computer operations are requested or triggered to obtain data for use by the system 130. As an example, the CLIMATE FIELDVIEW application, commercially available from The Climate Corporation, San Francisco, Calif., may be operated to export data to system 130 for storing in the repository 160.

For example, seed monitor systems can both control planter apparatus components and obtain planting data, including signals from seed sensors via a signal harness that comprises a CAN backbone and point-to-point connections for registration and/or diagnostics. Seed monitor systems can be programmed or configured to display seed spacing, population and other information to the user via the cab computer 115 or other devices within the system 130. Examples are disclosed in U.S. Pat. No. 8,738,243 and US Pat. Pub. 20150094916, and the present disclosure assumes knowledge of those other patent disclosures.

Likewise, yield monitor systems may contain yield sensors for harvester apparatus that send yield measurement data to the cab computer 115 or other devices within the system 130. Yield monitor systems may utilize one or more remote sensors 112 to obtain grain moisture measurements in a combine or other harvester and transmit these measurements to the user via the cab computer 115 or other devices within the system 130.

In some embodiments, examples of sensors 112 that may be used with any moving vehicle or apparatus of the type described elsewhere herein include kinematic sensors and position sensors. Kinematic sensors may comprise any of speed sensors such as radar or wheel speed sensors, accelerometers, or gyros. Position sensors may comprise GPS receivers or transceivers, or Wi-Fi-based position or mapping apps that are programmed to determine location based upon nearby Wi-Fi hotspots, among others.

In some embodiments, examples of sensors 112 that may be used with tractors or other moving vehicles include engine speed sensors, fuel consumption sensors, area counters or distance counters that interact with GPS or radar signals, PTO (power take-off) speed sensors, tractor hydraulics sensors configured to detect hydraulics parameters such as pressure or flow, and/or and hydraulic pump speed, wheel speed sensors or wheel slippage sensors. In some embodiments, examples of controllers 114 that may be used with tractors include hydraulic directional controllers, pressure controllers, and/or flow controllers; hydraulic pump speed controllers; speed controllers or governors; hitch position controllers; or wheel position controllers provide automatic steering.

In some embodiments, examples of sensors 112 that may be used with seed planting equipment such as planters, drills, or air seeders include seed sensors, which may be optical, electromagnetic, or impact sensors; downforce sensors such as load pins, load cells, pressure sensors; soil property sensors such as reflectivity sensors, moisture sensors, electrical conductivity sensors, optical residue sensors, or temperature sensors; component operating criteria sensors such as planting depth sensors, downforce cylinder pressure sensors, seed disc speed sensors, seed drive motor encoders, seed conveyor system speed sensors, or vacuum level sensors; or pesticide application sensors such as optical or other electromagnetic sensors, or impact sensors. In some embodiments, examples of controllers 114 that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In some embodiments, examples of sensors 112 that may be used with tillage equipment include position sensors for tools such as shanks or discs; tool position sensors for such tools that are configured to detect depth, gang angle, or lateral spacing; downforce sensors; or draft force sensors. In some embodiments, examples of controllers 114 that may be used with tillage equipment include downforce controllers or tool position controllers, such as controllers configured to control tool depth, gang angle, or lateral spacing.

In some embodiments, examples of sensors 112 that may be used in relation to apparatus for applying fertilizer, insecticide, fungicide and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors such as accelerometers disposed on sprayer booms. In some embodiments, examples of controllers 114 that may be used with such apparatus include pump speed controllers; valve controllers that are programmed to control pressure, flow, direction, PWM and the like; or position actuators, such as for boom height, subsoiler depth, or boom position.

In some embodiments, examples of sensors 112 that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In some embodiments, examples of controllers 114 that may be used with harvesters include header operating criteria controllers for elements such as header height, header type, deck plate gap, feeder speed, or reel speed; separator operating criteria controllers for features such as concave clearance, rotor speed, shoe clearance, or chaffer clearance; or controllers for auger position, operation, or speed.

In some embodiments, examples of sensors 112 that may be used with grain carts include weight sensors, or sensors for auger position, operation, or speed. In some embodiments, examples of controllers 114 that may be used with grain carts include controllers for auger position, operation, or speed.

In some embodiments, examples of sensors 112 and controllers 114 may be installed in unmanned aerial vehicle (UAV) apparatus or “drones.” Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus; other electromagnetic radiation emitters and reflected electromagnetic radiation detection apparatus. Such controllers may include guidance or motor control apparatus, control surface controllers, camera controllers, or controllers programmed to turn on, operate, obtain data from, manage and configure any of the foregoing sensors. Examples are disclosed in U.S. patent application Ser. No. 14/831,165 and the present disclosure assumes knowledge of that other patent disclosure.

In some embodiments, sensors 112 and controllers 114 may be affixed to soil sampling and measurement apparatus that is configured or programmed to sample soil and perform soil chemistry tests, soil moisture tests, and other tests pertaining to soil. For example, the apparatus disclosed in U.S. Pat. Nos. 8,767,194 and 8,712,148 may be used, and the present disclosure assumes knowledge of those patent disclosures.

In some embodiments, sensors 112 and controllers 114 may comprise weather devices for monitoring weather conditions of fields. For example, the apparatus disclosed in U.S. Provisional Application No. 62/154,207, filed on Apr. 29, 2015, U.S. Provisional Application No. 62/175,160, filed on Jun. 12, 2015, U.S. Provisional Application No. 62/198,060, filed on Jul. 28, 2015, and U.S. Provisional Application No. 62/220,852, filed on Sep. 18, 2015, may be used, and the present disclosure assumes knowledge of those patent disclosures.

### 2.4. Process Overview-Agronomic Model Training

In some embodiments, the agricultural intelligence computer system 130 is programmed or configured to create an agronomic model. In this context, an agronomic model is a data structure in memory of the agricultural intelligence computer system 130 that comprises field data 106, such as identification data and harvest data for one or more fields. The agronomic model may also comprise calculated agronomic properties which describe either conditions which may affect the growth of one or more crops on a field, or properties of the one or more crops, or both. Additionally, an agronomic model may comprise recommendations based on agronomic factors such as crop recommendations, irrigation recommendations, planting recommendations, fertilizer recommendations, fungicide recommendations, pesticide recommendations, harvesting recommendations and other crop management recommendations. The agronomic factors may also be used to estimate one or more crop related results, such as agronomic yield. The agronomic yield of a crop is an estimate of quantity of the crop that is produced, or in some examples the revenue or profit obtained from the produced crop.

In some embodiments, the agricultural intelligence computer system 130 may use a preconfigured agronomic model to calculate agronomic properties related to currently received location and crop information for one or more fields. The preconfigured agronomic model is based upon previously processed field data, including but not limited to, identification data, harvest data, fertilizer data, and weather data. The preconfigured agronomic model may have been cross validated to ensure accuracy of the model. Cross validation may include comparison to ground truthing that compares predicted results with actual results on a field, such as a comparison of precipitation estimate with a rain gauge or sensor providing weather data at the same or nearby location or an estimate of nitrogen content with a soil sample measurement.

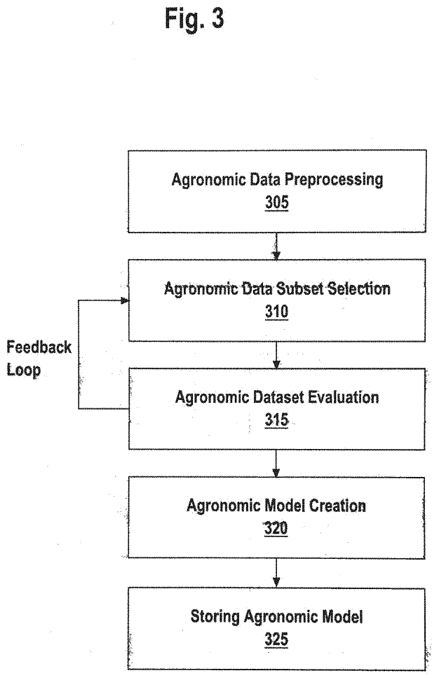

FIG. 3 shows a programmed process by which the agricultural intelligence computer system generates one or more preconfigured agronomic models using agronomic data provided by one or more data sources. FIG. 3 may serve as an algorithm or instructions for programming the functional elements of the agricultural intelligence computer system 130 to perform the operations that are now described.

At block 305, the agricultural intelligence computer system 130 is configured or programmed to implement agronomic data preprocessing of field data received from one or more data sources. The field data received from one or more data sources may be preprocessed for the purpose of removing noise, distorting effects, and confounding factors within the agronomic data including measured outliers that could adversely affect received field data values. Embodiments of agronomic data preprocessing may include, but are not limited to, removing data values commonly associated with outlier data values, specific measured data points that are known to unnecessarily skew other data values, data smoothing, aggregation, or sampling techniques used to remove or reduce additive or multiplicative effects from noise, and other filtering or data derivation techniques used to provide clear distinctions between positive and negative data inputs.

At block 310, the agricultural intelligence computer system 130 is configured or programmed to perform data subset selection using the preprocessed field data in order to identify datasets useful for initial agronomic model generation. The agricultural intelligence computer system 130 may implement data subset selection techniques including, but not limited to, a genetic algorithm method, an all subset models method, a sequential search method, a stepwise regression method, a particle swarm optimization method, and an ant colony optimization method. For example, a genetic algorithm selection technique uses an adaptive heuristic search algorithm, based on evolutionary principles of natural selection and genetics, to determine and evaluate datasets within the preprocessed agronomic data.

At block 315, the agricultural intelligence computer system 130 is configured or programmed to implement field dataset evaluation. In some embodiments, a specific field dataset is evaluated by creating an agronomic model and using specific quality thresholds for the created agronomic model. Agronomic models may be compared and/or validated using one or more comparison techniques, such as, but not limited to, root mean square error with leave-one-out cross validation (RMSECV), mean absolute error, and mean percentage error. For example, RMSECV can cross validate agronomic models by comparing predicted agronomic property values created by the agronomic model against historical agronomic property values collected and analyzed. In some embodiments, the agronomic dataset evaluation logic is used as a feedback loop where agronomic datasets that do not meet configured quality thresholds are used during future data subset selection steps (block 310).

At block 320, the agricultural intelligence computer system 130 is configured or programmed to implement agronomic model creation based upon the cross validated agronomic datasets. In some embodiments, agronomic model creation may implement multivariate regression techniques to create preconfigured agronomic data models.

At block 325, the agricultural intelligence computer system 130 is configured or programmed to store the preconfigured agronomic data models for future field data evaluation.

### 2.5. Implementation Example—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 4 is a block diagram that shows a computer system upon which some embodiments of the invention may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random-access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infrared data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infrared signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated-services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 3. Structural and Functional Description

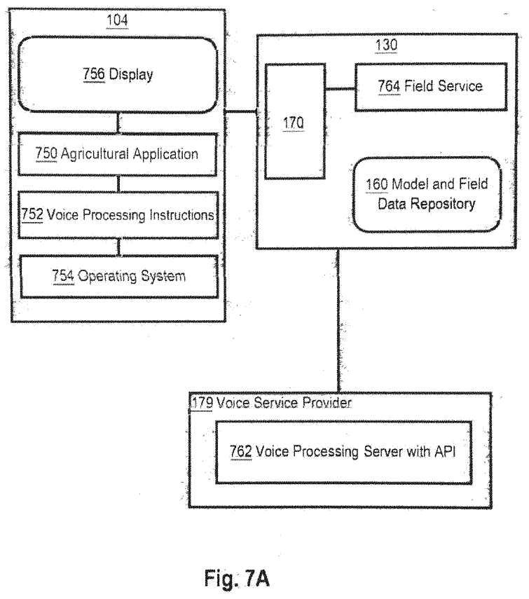

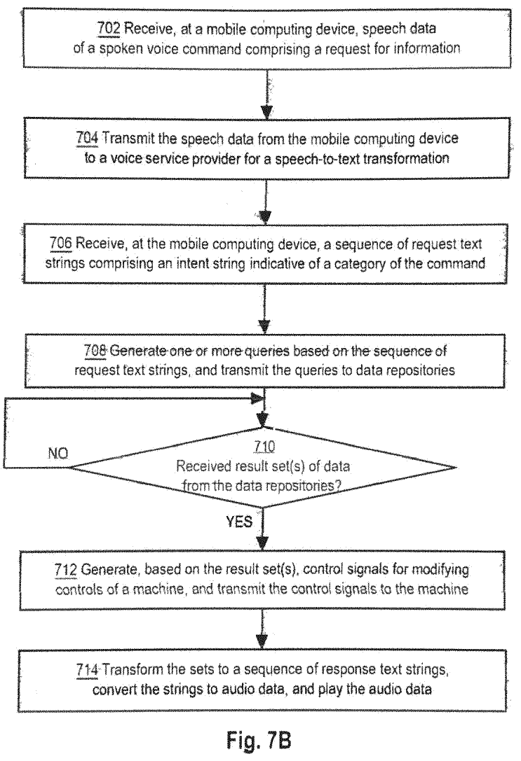

FIG. 7A shows an example computer system that is programmed to process voice commands for use with agricultural applications, while FIG. 7B shows an example computer-implemented process for manipulating a voice-integrated agricultural intelligence computer system through a voice interface. FIG. 7B is intended to disclose an algorithm or functional description that may be used as a basis of writing computer programs to implement the functions that are described herein, and which may cause a computer to operate in the new manner that is disclosed herein. Furthermore, FIG. 7B is provided to communicate such an algorithm at the same level of detail that is normally used, by persons of skill in the art to which this disclosure is directed, to communicate among themselves about plans, designs, specifications and algorithms for other computer programs of a similar level of complexity.

### 3.1. Overview of Example Voice Processing System

Referring first to FIG. 7A, in some embodiments mobile computing device 104 (FIG. 1A) comprises an operating system 754, voice processing instructions 752, an agricultural application 750 and touch-sensitive display 756. In some embodiments operating system 754 may be any operating system configured to provide support for touch-sensitive display 756, application 750 and voice processing instructions 752.

Voice processing instructions 752 may be configured to provide location-determining functionalities, audio recording functionalities, computing capability to trigger recording of digital sound data as speech is spoken by a user of device 104 and to interoperate with agricultural application 750 to transmit the captured audio recording of spoken voice commands to agricultural intelligence computer system 130 and specifically to voice controller service 170.

Agricultural application 750 may implement field data viewing functions, data search query and retrieval, recommendations functions, equipment control functions, retrieval of weather data or other agricultural applications. Agricultural application 750 may be configured to generate and update touch-sensitive display 756 to display a graphical user interface and/or receive taps, gestures or other touch signals to interact with functions of the application.

Agricultural application 750 may be configured to facilitate wireless communications between the components of computers 104, 130 and voice service provider 179. The communications may be sent using wireless network protocols and may allow interactions between, for example, voice controller service 170 and agricultural intelligence computer system 130. Depending on the intent expressed in a voice command, both described in detail later, upon receiving data representing the intent, voice controller service 170 may invoke a field service 764 to cause field service 764 to query repository 160 to retrieve result data for a spoken response. Alternatively, voice controller service 170 may invoke repository 160 to cause repository 160 to retrieve instructions. The instructions may be transmitted to device 104 to cause agricultural application 750, executing on device 104, to, for example, change state or control computer 130.

In some embodiments, a voice-skills-kit may be used to provide support for programming voice processing instructions 752 or voice controller service 170. Voice controller service 170 and/or voice service provider 179 may execute code that is compatible with agricultural application 750. In some embodiments, voice service provider 179 may host or execute a voice processing server with an API 762 implementing the voice-skills-kit-services. For the purpose of illustrating an example, AMAZON ALEXA™ may be used to implement a voice service provider and/or voice-skills-kit services, but any other voice service tool can be used.

In some embodiments, voice controller service 170 may be programmed to make a call voice processing server 762 using specified function calls to accomplish parsing of recordings into intents. In some embodiments, server 762 may be hosted or executed using a cloud computing service such as Amazon Web Services™, such as AWS Lambda™.

Voice processing instructions may be programmed to add voice interactivity to the agricultural application in the manner further described herein. In some embodiments, the agricultural application is programmed to interoperate with, for example, NUANCE MIX software. A system implementing the NUANCE MIX software provides a RESTful API interface in which the agricultural application may upload text in a request and receive voice-band PCM data in response for local playback at the device. In some embodiments, an application for Amazon Echo™ may integrate the voice capabilities provided by the voice-skills-services.

Voice processing instructions 752 may be programmed to use a normalized request-response protocol that is compatible with any form of back-end service, as represented by voice controller service 170 and server 762. This approach permits substitution of different voice service providers such as NUANCE™, AMAZON™, GOOGLE™ or SIRI™ from time to time.

In some embodiments, agricultural intelligence computer system 130 receives a voice command issued by a user. A voice command herein refers to a spoken phrase, statement or an instruction prompting agricultural intelligence computer system 130 to perform certain actions. Example voice commands include “how much rain did I get on Feb. 6, 2018?” or “read the latest notifications.”

A voice command may be issued in various ways by a user to express a question, request, or statement. However, differently phrased voice commands can result in the same response. For example, voice commands of “how much rain did I get yesterday?” and “what was yesterday's rainfall?” can be sentenced differently but can lead to the same response (e.g., “we received two inches of rain”).

In some embodiments, a voice command includes one or more parameter values and/or one or more intents. A parameter value is a specific value that may be used as a key in a query. For example, if a voice command includes “what was the average precipitation on Jan. 1, 2018?”, then a parameter value in this voice command is “Jan. 1, 2018” and the parameter type is “date.” According to another example, if a voice command includes “what is the average wind speed in Southfield in February 2018?”, then parameter values in this voice command are “February 2018” and “Southfield”, and the parameter types are “date” and “city,” respectively.

An intent represents a specific keyword or a concept that represents a category of the voice command. Phrases that are structured differently can include an identical intent. For example, voice commands of “what is my nitrogen shortfall” and “how is my nitrogen” may both include a “nitrogen” intent.

Voice commands may be aggregated, processed and stored. Each voice command may be analyzed to define a set of intents. Each voice command phrase may be classified into a corresponding category of intent (e.g., weather) and updated based on the input parameter values.

### 3.2. Intent Examples

Intents may represent specific keywords or concepts conveyed in voice commands. The intents may be defined by agricultural intelligence computer system 130 and stored in repository 160. For each intent, numerous permutations of intents can be arranged. Experimental designs may implement, for example, over 3,400 permutations of intents in over a dozen categories. The categories may include “WeatherIntent”, “DialogHistoricalWeatherIntent”, “RainThresholdIntent”, “NotificationIntent”, “ReadNotificationsIntent”, “TopicHelpIntent”, “HelpIntent”, “ImageryIntent”, “NitrogenIntent”, “FieldIntent”, “ThanksIntent”, “ReadFieldPlantingIntent”, “CreateFieldPlantingIntent”, “HelpIntent”. Other embodiments may implement more categories, fewer categories or different categories. Examples of permutations of intents are as follows:

Example permutations of “dialog historical weather intent” can include:

DialogHistoricalWeatherIntent what about {date}
DialogHistoricalWeatherintent what was it {date}
DialogHistoricalWeatherintent what was it on {date}

Example permutations of “weather intent” can include:

WeatherIntent for weather on {homestead|field}
WeatherIntent for weather on {back forty|field}
WeatherIntent for weather on {south of home|field}
WeatherIntent for weather on {north of the avenue|field}
WeatherIntent for weather on {grandma garden new thirty addition|field}
WeatherIntent for weather on {high clay new slough addition south|field}
WeatherIntent for weather on {high sand old drumlin plot south west|field}
WeatherIntent for weather on {low organic matter on crest east by south|field}
WeatherIntent for weather on field {homestead|field}
WeatherIntent for weather on field {back forty|field}
WeatherIntent for weather on field {south of home|field}
WeatherIntent for weather on field {north of the avenue|field}
WeatherIntent for weather on field {grandma garden new thirty addition|field}
WeatherIntent for weather on field {high clay new slough addition south|field}
WeatherIntent for weather on field {high sand old drumlin plot south west|field}
WeatherIntent for weather on field {low organic matter on crest east by south|field}
WeatherIntent for the weather on {homestead|field}
WeatherIntent for the weather on {back forty|field}
WeatherIntent for the weather on {south of home|field}
WeatherIntent for the weather on {north of the avenue|field}
WeatherIntent for the weather on {grandma garden new thirty addition|field}
WeatherIntent for the weather on {high clay new slough addition south|field}
WeatherIntent for the weather on {high sand old drumlin plot south west|field}
WeatherIntent for the weather on {low organic matter on crest east by south|field}
WeatherIntent for the weather on field {homestead|field}
WeatherIntent for the weather on field {back forty|field}
WeatherIntent for the weather on field {south of home|field}
WeatherIntent for the weather on field {north of the avenue|field}
WeatherIntent for the weather on field {grandma garden new thirty addition|field}
WeatherIntent for the weather on field {high clay new slough addition south|field}
WeatherIntent for the weather on field {high sand old drumlin plot south west|field}
WeatherIntent for the weather on field {low organic matter on crest east by south|field}
WeatherIntent what is the weather on {homestead|field}
WeatherIntent what is the weather on {back forty|field}
WeatherIntent what is the weather on {south of home|field}
WeatherIntent what is the weather on {north of the avenue|field}
WeatherIntent what is the weather on {grandma garden new thirty addition|field}
WeatherIntent what is the weather on {high clay new slough addition south|field}
WeatherIntent what is the weather on {high sand old drumlin plot south west|field}
WeatherIntent what is the weather on {low organic matter on crest east by south|field}
WeatherIntent what's the weather on {homestead|field}
WeatherIntent what's the weather on {back forty|field}
WeatherIntent what's the weather on {south of home|field}
WeatherIntent what's the weather on {north of the avenue|field}
WeatherIntent what's the weather on {grandma garden new thirty addition|field}
WeatherIntent what's the weather on {high clay new slough addition south|field}
WeatherIntent what's the weather on {high sand old drumlin plot south west|field}
WeatherIntent what's the weather on {low organic matter on crest east by south|field}

Example permutations of “notification intent” can include:

NotificationIntent if there are notifications
NotificationIntent if there are new notifications
NotificationIntent if I have notifications
NotificationIntent if I have new notifications
NotificationIntent if I have any notifications
NotificationIntent if I have any new notifications
NotificationIntent do I have notifications
NotificationIntent do I have new notifications
NotificationIntent do I have any notifications

Example permutations of “read notifications intent” can include:

ReadNotificationsIntent read the last {count} notifications
ReadNotificationsIntent read last {count} notifications
ReadNotificationsIntent read {count} notifications
ReadNotificationsIntent read {count} notification
ReadNotificationsIntent read last notifications
ReadNotificationsIntent read notifications
ReadNotificationsIntent to read the last {count} notifications
ReadNotificationsIntent to read last {count} notifications
ReadNotificationsIntent to read {count} notifications
ReadNotificationsIntent to read {count} notification
ReadNotificationsIntent to read last notifications
ReadNotificationsIntent to read notifications

Example permutations of “imagery intent” can include:

ImageryIntent do any of my fields have new imagery
ImageryIntent what fields have new imagery
ImageryIntent do I have imagery
ImageryIntent do I have new imagery
ImageryIntent do I have any imagery
ImageryIntent do I have any new imagery
ImageryIntent do I have any new field imagery
ImageryIntent do I have any field imagery
ImageryIntent do any fields have new imagery
ImageryIntent do any fields have imagery
ImageryIntent what fields have imagery
ImageryIntent what fields have new imagery

Example permutations of “thanks intent” can include:

ThanksIntent thank you
ThanksIntent thanks
Example permutations of “field intent” can include:
FieldIntent what are my fields
FieldIntent what are my field names
FieldIntent what are the names of my fields

Example permutations of “help intent” can include:

Helpintent help
HelpIntent I need help

Example permutations of “topic help intent” can include:

TopicHelpintent list topics
TopicHelpintent help {topic|helptopic}
TopicHelpintent help {topic help|helptopic}
TopicHelpintent help with {topic|helptopic}
TopicHelpintent help with {topic help|helptopic}
TopicHelpintent I need help with {topic|helptopic}
TopicHelpintent I need help with {topic help|helptopic}

Example permutations of “rain threshold intent” can include:

RainThresholdIntent if I got more than {threshold} inches of rain anywhere {date}
RainThresholdIntent if I got more than {threshold} inch of rain anywhere {date}
RainThresholdIntent if I got more than a {threshold} inch of rain anywhere {date}
RainThresholdIntent if I got more than {threshold} inches of rain on my fields {date}
RainThresholdIntent if I got more than {threshold} inch of rain on my fields {date}
RainThresholdIntent if I got more than a {threshold} inch of rain on my fields {date}
RainThresholdIntent if I got more than {threshold} inches of rain on any of my fields {date}
RainThresholdIntent if I got more than {threshold} inch of rain on any of my fields {date}
RainThresholdIntent if I got more than a {threshold} inch of rain on any of my fields {date}
RainThresholdIntent if any of my fields got more than {threshold} inches of rain {date}
RainThresholdIntent if any of my fields got more than {threshold} inch of rain {date}
RainThresholdIntent if any of my fields got more than a {threshold} inch of rain {date}

Example permutations of “read field planting intent” can include:

ReadFieldPlantingIntent when was planting on field {homestead|field}
ReadFieldPlantingIntent when was planting on field {back forty|field}
ReadFieldPlantingIntent when was planting on field {south of home|field}
ReadFieldPlantingIntent when was planting on field {north of the avenue|field}
ReadFieldPlantingIntent when was planting on field {grandma garden new thirty addition|field}
ReadFieldPlantingIntent when was planting on field {high clay new slough addition south|field}
ReadFieldPlantingIntent when was planting on field {high sand old drumlin plot south west|field}
ReadFieldPlantingIntent when was planting on field {low organic matter on crest east by south|field}
ReadFieldPlantingIntent when did I plant field {homestead|field}
ReadFieldPlantingIntent when did I plant field {back forty|field}
ReadFieldPlantingIntent when did I plant field {south of home|field}
ReadFieldPlantingIntent when did I plant field {north of the avenue|field}
ReadFieldPlantingIntent when did I plant field {grandma garden new thirty addition|field}
ReadFieldPlantingIntent when did I plant field {high clay new slough addition south|field}
ReadFieldPlantingIntent when did I plant field {high sand old drumlin plot south west|field}
ReadFieldPlantingIntent when did I plant field {low organic matter on crest east by south|field}
ReadFieldPlantingIntent for planting information on field {homestead|field}
ReadFieldPlantingIntent for planting information on field {back forty|field}
ReadFieldPlantingIntent for planting information on field {south of home|field}
ReadFieldPlantingIntent for planting information on field {north of the avenue|field}
ReadFieldPlantingIntent for planting information on field {grandma garden new thirty addition|field}
ReadFieldPlantingIntent for planting information on field {high clay new slough addition south|field}
ReadFieldPlantingIntent for planting information on field {high sand old drumlin plot south west|field}
ReadFieldPlantingIntent for planting information on field {low organic matter on crest east by south|field}
ReadFieldPlantingIntent when did I plant it
ReadFieldPlantingIntent when did I plant

Example permutations of “create field planting intent” can include:

CreateFieldPlantingIntent add planting on field {homestead|field}
CreateFieldPlantingIntent add planting on field {back forty|field}
CreateFieldPlantingIntent add planting on field {south of home|field}
CreateFieldPlantingIntent add planting on field {north of the avenue|field}
CreateFieldPlantingIntent add planting on field {grandma garden new thirty addition|field}
CreateFieldPlantingIntent add planting on field {high clay new slough addition south|field}
CreateFieldPlantingIntent add planting on field {high sand old drumlin plot south west|field}
CreateFieldPlantingIntent add planting on field {low organic matter on crest east by south|field}
CreateFieldPlantingIntent add planting for field {homestead|field}
CreateFieldPlantingIntent add planting for field {back forty|field}
CreateFieldPlantingIntent add planting for field {south of home|field}
CreateFieldPlantingIntent add planting for field {north of the avenue|field}
CreateFieldPlantingIntent add planting for field {grandma garden new thirty addition|field}
CreateFieldPlantingIntent add planting for field {high clay new slough addition south|field}
CreateFieldPlantingIntent add planting for field {high sand old drumlin plot south west|field}
CreateFieldPlantingIntent add planting for field {low organic matter on crest east by south|field}
CreateFieldPlantingIntent add planting activity for field {homestead|field}
CreateFieldPlantingIntent add planting activity for field {back forty|field}
CreateFieldPlantingIntent add planting activity for field {south of home|field}
CreateFieldPlantingIntent add planting activity for field {north of the avenue|field}
CreateFieldPlantingIntent add planting activity for field {grandma garden new thirty addition|field}
CreateFieldPlantingIntent add planting activity for field {high clay new slough addition south|field}
CreateFieldPlantingIntent add planting activity for field {high sand old drumlin plot south west|field}
CreateFieldPlantingIntent add planting activity for field {low organic matter on crest east by south|field}
CreateFieldPlantingIntent I planted field {homestead|field}
CreateFieldPlantingIntent I planted field {back forty|field}
CreateFieldPlantingIntent I planted field {south of home|field}
CreateFieldPlantingIntent I planted field {north of the avenue|field}
CreateFieldPlantingIntent I planted field {grandma garden new thirty addition|field}
CreateFieldPlantingIntent I planted field {high clay new slough addition south|field}
CreateFieldPlantingIntent I planted field {high sand old drumlin plot south west|field}
CreateFieldPlantingIntent I planted field {low organic matter on crest east by south|field}

Example permutations of “nitrogen intent” can include:

NitrogenIntent do I have any nitrogen shortfall
NitrogenIntent do I have any nitrogen shortfalls
NitrogenIntent do any fields have nitrogen shortfalls
NitrogenIntent do any fields have nitrogen shortfall
NitrogenIntent what's my nitrogen shortfalls
NitrogenIntent what's my nitrogen shortfall
NitrogenIntent how's my nitrogen
NitrogenIntent how is my nitrogen
NitrogenIntent any shortfalls

Other embodiments may implement more intents, fewer intents or different intents. Furthermore, the intents may vary based upon the voice service provider that is configured at the back-end. For example, the NUANCE service supports intents of the form “SHOW ME FIELDS THAT ARE . . . ” followed by an attribute. In these embodiments, the response from the NUANCE system can be translated to specific screen displays of the agricultural application that should be shown to support the query.

### 3.3. Sets of Known Intents

Agricultural intelligence computer system 130 may store a set of known intents in advance and use the set of known intents to classify an intent received in a voice command. The set of known intents may be sent to a voice service provider, such as AMAZON ALEXA™ or any other virtual assistant voice service.

A voice service provider may be communicatively coupled to agricultural intelligence computer system 130 or may be implemented as part of agricultural intelligence computer system 130. Voice service provider may be configured to receive a set of configuration files that includes a set of intents from agricultural intelligence computer system 130. The voice service provider may store the set of intents in a database and use the set for performing a speech analysis.

Agricultural intelligence computer system 130 may receive an update to the set of known intents. Upon receiving the update, computer system 130 may transmit the update to the voice service provider. The update may include addition, removal, or changes to the intents.

### 4. Example Voice Commands

In some embodiments, agricultural intelligence computer system 130 receives a voice command that is initiated by an agricultural application executing on a portable computing device. A user operating the portable computing device can interact with the agricultural application to initiate a voice command capturing process by, for example, tapping a touch-sensitive button implemented in a user interface displayed on the portable device.

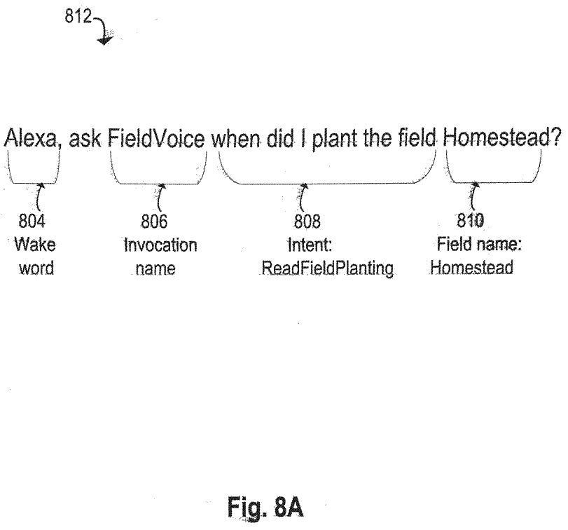

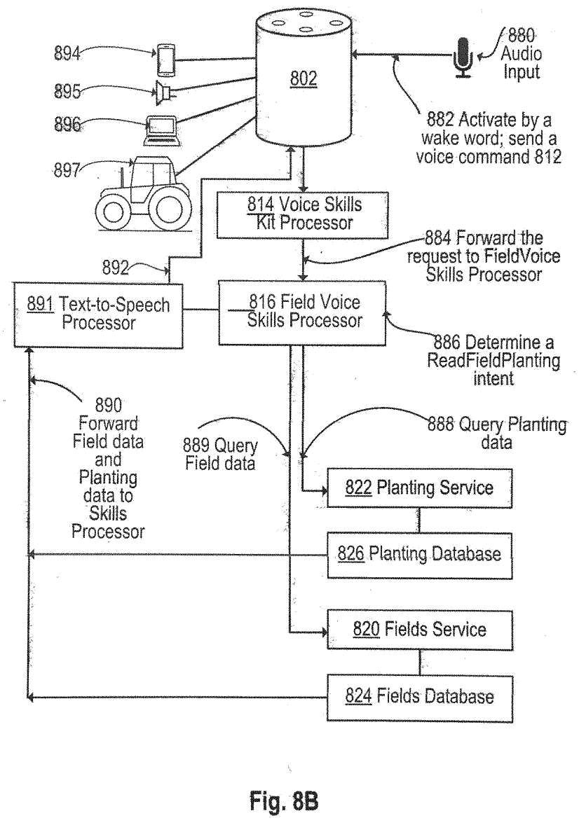

FIG. 8A shows an example voice command 812. In the example shown in FIG. 8A, voice command 812 comprises a wake word 804, invocation name 806, one or more intents 808 and one or more parameter values 810. In the depicted example, wake word 804 is “Alexa” and is used to address, or trigger, a voice provider service described below. Invocation name 806 is “FieldVoice” and is used to recognize an invocation name of a processor configured to handle the voice command. Intent 808 is “ReadFieldPlanting” and is used to indicate the intent of voice command 812 in terms of the type of the intended request. Field name 810 includes “Homestead” and indicates the name of the field for which information is sought. The wake-words are used to trigger a voice capturing process, and the remaining information in the voice command is used to specify the type of information that is requested.

For example, a voice capturing process may be triggered by issuing a wake-word or tapping a button on the portable computing device. A non-limiting example of wake-words is “Alexa.” In some embodiments, the wake-word activates the voice service provider to recognize an invocation name (“FieldVoice”). For example, a user may issue a phrase “Alexa, ask FieldVoice, when did I plant field Homestead?” In this case, Alexa may be a wake-word and FieldVoice may be an invocation name.

Upon receiving the voice command, the agricultural application may capture the audio data and send the audio data to agricultural intelligence computer system 130, which may determine a response to the voice command. The response may include an audible response that may be played on the portable device. The response may also include, for example, report data requested by the user in the voice command. The report data may be displayed on the user interface.

Suppose, for example, that the portable computing device displays a user interface showing a rainfall report, a soil type report, a yield report, and/or satellite images of a field. Each display of the report may be integrated with interactive capabilities that can be accessible via, for example, touch-buttons or touch-points available on the interface generated by the portable computing device. The touch-buttons/points may be managed by the applications that are part of the interface provided by the portable computing device and that execute in the portable computing device. The applications may be programmed to receive spoken voice commands and respond to the commands with audible responses.

### 5. Example Implementation Methods

Referring to FIG. 7B, at step 702, agricultural intelligence computer 130 receives a voice command from a portable computing device. The portable computing device may be any computing device that is implemented in the agricultural equipment or configured to communicate with the agricultural equipment to view, retrieve or request agricultural information. For example, the portable computing device can be field manager computing device 104 or cab computer 115 that is implemented on agricultural apparatus 111 (shown in FIG. 1A). The portable computing device is referred to herein also as a mobile computing device.

A user of the portable computing device may use a user interface provided by the device to request providing field information, receive the requested information and view the information. The information may include weather information for the field, an amount of rainfall in a specific area pf the field, planting information, nutrient information for the field, and the like. The user can also use the interface of the device to create and store certain agricultural information, such as scouting notes, scouting observations about the field, questions to be asked in the future, and the like.

In some embodiments, a portable computing device may include a voice-activated audio component. The voice-activated audio component may be configured to capture voice command audio data, record the audio data, and play response audio data. The voice-activated audio component may include an integrated chipset that functions as an audio controller, a microphone, a recorder, a speaker or a combination thereof. The voice-activated audio component may be used to work with agricultural intelligence computer system 130 to capture voice commands and play audio responses generated for the voice commands. With the voice-activated audio component, a voice command may be captured as an audio file expressed in any audio file format.

The voice-activated audio component may be also triggered by pressing a virtual button provided in the user interface displayed in the portable device and configured to initiate audio capturing. Examples of the virtual button may include a microphone icon or an audio icon. By pressing such a button, the user may provide touch input to an agricultural application executing on the portable computing device to initiate recording of an audio command and to issue the audio command.

The voice-activated audio component may be also triggered by pressing a physical button implemented on a physical agricultural device and configured to initiate audio capturing. Examples of the physical button may include a microphone switch or an audio button. By pressing such a button, the user may start a voice capturing process. The voice capturing process allows capturing a voice command using the microphone and digitizes the audio recording.

In response to initiating the speech capturing process, an audio-interface can be initiated. The interface can create a session to collect one or more recognized voice commands and record a speech of voice interaction. The interface may initiate a feedback loop if the voice command requires additional context such as repeating the voice command and/or providing one or more parameter values. The audio interface may generate a response with a request for more information from the user until enough context has been created. For example, if the captured voice command is not clear, then a request for clarification, such as “I don't understand that”, can be played back to a user to request that the user provide another voice command that is phrased differently. According to another example, in response to a “when did I plant field” voice command, a response “which field are you referring to?” may be generated to request a specific field identification.

At step 704, agricultural intelligence computer 130 transmits the captured voice command to a voice service provider via, for example, a computer network. In some embodiments, agricultural intelligence computer system 130 creates an HTTP request that includes the voice command and transmits the HTTP request using the IP protocol over one or more networks (e.g., the Internet) to a voice service provider. The HTTP request may include an audio file that comprises the voice command, an Application Programming Interface (API) call, and optionally one or more parameter values.

Upon receiving the speech data, the voice service provider may perform speech recognition operations such as speech-to-text operations. The voice service provider may use a natural language processing model to identify one or more intents and parameters included in the voice command. To perform such a task, the voice service provider may use one or more internal software tools, such as ALEXA SKILLS KIT™—software for learning a set of skills for performing tasks, ALEXA VOICE SERVICES™—software for voice-controlled artificial intelligence assistant, or AWS LAMBDA™—a serverless compute service.

Once the voice service provider receives the recorded voice command, the voice service provider may perform a speech recognition operation on the voice command using a natural language processing model. The voice service provider may, for example, parse the audio file (e.g., a .wav file) into a set of text strings and compare each of the text strings to the text strings of the set of known intents to identify at least one intent and one or more parameter values, if such are included in the voice command.

In some embodiments, agricultural intelligence computer system 130 provides a specific code to the voice service provider to process the natural language processing model to determine intents and parameter values from the speech data. A parameter value may represent a value that is required from a user to respond to the voice command correctly. In some embodiments, the parameter values are identified based on recognized patterns of phrases or converted texts.

Suppose that the voice command is “when did I plant field homestead?” The voice service provider may transform the voice command into a set of text strings and parse the text strings to determine whether the text strings include, for example, a “ReadFieldPlanting” intent. According to another example, if the voice command is “what is the average wind speed in the south field in February 2018”, then the voice service provider may transform the voice command into a set of text strings and parse the text strings to determine whether the text strings include, for example, the parameters “February 2018” and “south field.”

Upon identifying one or more intents and/or one or more parameters, the voice service provider may send the set of text strings comprising at least one intent and at least one parameter value to agricultural intelligence computer 139. As a result, at step 706, agricultural intelligence computer system 130 receives the set of text strings from the voice service provider. The set of text strings is also referred to as a set of request text string.

If additional parameters or context data are required to retrieve specific field information, conversation component 184 may return a response requesting more information until sufficient contexts or parameters are collected to form queries to data repositories.

At step 708, agricultural computer 130 generates one or more queries based on the set of request text strings and transmits the queries to data repositories. The data repositories are queried to retrieve the data requested by the voice command. For each intent, agricultural intelligence computer system 130 may, for example, maintain a corresponding data repository that includes data specific to the intent. For example, for a “weather” intent, model and field data repository 160 may maintain a “weather” data repository that may include statistical weather data, such as temperature, humidity, or wind for each section of the field. According to another example, for a “nitrogen” intent, model and field data repository 160 may maintain a “nitrogen” data repository that includes fertilizer data and statistics of the nitrogen shortfall.

The query process may be performed by requesting information specific to the received intent and the received parameter values. In some embodiments, the query process initiates a sequence of calls to retrieve the data from the data repositories and is programmed to make one or more programming calls to the relevant repositories.

For example, in response to a voice command “when did I plant field homestead?”, intent handler component 186 identifies an intent “ReadFieldPlanting” intent and a parameter value “Homestead” and determines that two queries may be needed: one query, including the “Homestead” parameter value, to the “fields” database and another query to the “planting” database to query planting data. The first query can identify a field (“Homestead”) and retrieve information regarding the field such as boundaries, size, or parcel. The second query can identify planting data information such as date or plan for the homestead field.

In step 710, agricultural intelligence computer 130 checks if one or more result sets of data have been received from data repositories. If no data have been received, then step 710 is repeated. Otherwise, step 712

In step 712, one or more result sets of data are received and used to generate, for example, control signals for automatically modifying controls of an agricultural machine. The control signals may be transmitted to the machine to automatically control the machine as the machine performs agricultural tasks such as planting, fertilizing, harvesting, seeding, and the like. For example, the control signals may include signals that are configured to automatically trigger a planting/seeding mechanism installed on the agricultural machine to dispense the seeds, or to automatically trigger a fertilizing mechanism installed on the agricultural machine to dispense fertilizer to the soil, or to automatically trigger a harvesting mechanism to start harvesting crops.

In step 714, the one or more result sets of data may be used to generate audio statements. For example, the query results may be formatted into a naturally-sounding output statement. The query results may be used to form a data structure that contains a pre-defined template to be spoken at the portable computing device. Examples of pre-defined templates may include a logic-less template.

One way of generating a logic-less template is using the MUSTACHE templating language. For example, a “weather” intent can include an example pre-defined template response such as “[A] field received [X] amount of rain.” A “notification” intent can include example pre-formed template responses such as “there are no new notifications” or “the first notification is [X].” The assigned slot [.] can be filled in with the information retrieved from the respective data repository. The rest of the response can be pre-defined based on the type of intent.

For example, for the “ReadFieldPlanting” intent, a pre-defined template such as “the field was planted on [date information retrieved from the field planting repository] can be stored in the “ReadFieldPlanting” intent data repository. When the database call is received with the a date, for example, of Feb. 23, 2018, the parameter value from the “ReadFieldPlanting” repository is retrieved and assigned a slot [.] to formulate the output statement using the pre-defined template associated with the “ReadFieldPlanting” intent. The output statement may be: “the field was planted on “Feb. 23, 2018.” The output statement may be structured in a text format, and later transformed to audio data by the voice service provider.

Also, in step 714, agricultural intelligence computer 130 sends a second sequence of text strings of the output statement to the voice service provider for text-to-speech transformation. The output statement may be converted into an audio file by the voice service provider. For example, the voice service provider may perform a text-to-speech transformation to convert the text file into an audio file using a Speech Synthesis Markup Language (SSML). The output statement may be sent as an HTTP request using a request-response protocol that enables communications between agricultural intelligence computer system 130 and the voice service provider server. Once the speech transformation is completed, the voice service provider sends the converted audio data to agricultural intelligence computer 130.

The audio data may be transmitted to the portable computing device for playing. The audio data may be formatted as an audio file and may include an output statement, i.e., an answer to the voice command. For example, the audio data may include a general response about the state of agronomic data, deficiency level, scouting information, yield outcome, weather notification, or planting information.

In another example, the output statement may include an instruction specifying a certain action to be performed in connection with another component at the portable computing device. The instruction may contain structured information that controls the user interface and allows changing the software or hardware controls on the device. The instructions can be broadcast to other components for execution on other connected devices.

Example instructions can include instructions to navigate other screens of computing devices (e.g., activate a screen) or applications (e.g., open an application on a user interface or open split view in an agricultural application). The instructions may also include instructions to enter data into the user interface (e.g., create a scouting note), instructions to control the equipment (e.g., stop the tractor, lift planter, reduce combined speed, start sprayer, engage auger on grain bin), instructions to generate a voice alert notifying the user of the field status (e.g., “Southfield received more than a threshold amount of rain”). Certain instructions allow hands-free experience and enable the user to control the software or hardware of agricultural device without manual operation.

At step 714, agricultural intelligence computer 130 may cause the portable computing device to play the audio data using, for example, a speaker connected to the portable computing device. The audio data may be also stored in a storage unit for future playback.

### 5. Example Processing of Voice Commands

FIG. 8B shows an embodiment for processing an example voice command 812 and represents a fully-worked example of the foregoing disclosure. Voice command 812 may be received via a microphone 880. Alternatively, voice command 812 may be received from a portable device such as a smartphone 894 or a laptop 896. Voice command may be also directly received by a voice-enabled device 802. Voice-enabled device 802 may be activated (step 882) or triggered using a wake-word, described above.

As shown in FIG. 8A, voice command 812 may include wake word 804, invocation name 806, intent 808 and field name 810. In some embodiments, voice command 812 may be converted to a digitized audio file and transmitted to a voice skills processor 814.

Voice skills kit processor 814 may be programmed using, for example, ALEXA SKILLS KIT™. Processor 814 may be configured to execute at least in part in a cloud computing center such as AWS LAMBDA™ and may be used to identify, in voice command 812, at least one intent such as “ReadFieldPlanting” intent 808 and, optionally, one or more parameter values such as “ReadFieldPlanting” 810, as shown in FIG. 8A.

In some embodiment, in response to detecting the intent and the parameters, processor 814 may forward (step 884) the intent and the parameters to a field voice skills processor 816, which may be configured to transform the intent and the parameters to a set of text strings.

Processor 816 may be configured to determine (step 886) the type of the intent and to determine one or more queries for collecting the requested data. For example, processor 816 may generate and transmit (steps 888 and 889) two queries to a fields service 820 and to a planting service 822 to query for data relating to the field “Homestead” and to query planting data. Note that a single intent may result in queries to one, two or more services and/or databases based on programmed logic of processor 816 using instructions, methods or objects specific to a particular intent.

Services 820 and 822 may call fields database 824 and planting database 826, respectively, to obtain the requested data. The requested data received from fields database 824 and/or planting database 826 may be then filtered, packaged or formatted into a response that is forwarded (step 890) to a text-to-speech processor 891.

Text-to-speech processor 891 may be configured to transform the textual response to an audible response, and may be implemented independently of voice skills kit processor 814, as shown in FIG. 8B. Alternatively, text-to-speech processor 891 may be implemented as a component of voice skills kit processor 814 and/or field voice skills processor 816 or may be integrated with voice skills kit processor 814 and/or field voice skills processor 816. Text-to-speech processor 891 may transform the textual response received from databases 824-826 to, for example, one or more audio files.

The one or more audio files may be transmitted (step 892) to, for example, voice-enabled device 802 and/or portable device 894, a speaker 895, laptop 896, and/or one or more agricultural machines 897. The audio files may be played on an audio-output-device installed in devices 802 and/or 894-897 to provide information and/or instructions requested in voice command 812.

### 6. Improvements Provided by Certain Embodiments

This disclosure has described practical embodiments of voice command systems for intelligent agricultural applications that fundamentally change the way that growers interact with field data systems. It is expected that the usage of voice commands will become second nature to growers and other users. Embodiments are particularly useful in the harsh environment typically experienced by users in agriculture; the environment may include users who are driving a truck, ATV, tractor or combine; users with dirty hands; users who are wearing gloves; and users working with mobile computing devices outdoors in bright sun or with cracked screens due to equipment damage.

The voice command systems and methods disclosed herein provide fast and practical means to interact with computer applications without the need for a user interface. The systems and methods provide ways to assist growers to focus and interpret data in context and concentrate on the substantive task rather than understanding how to work with a computer device.

What is claimed is:

1. A computer-implemented method comprising:
receiving, at a mobile computing device, speech data corresponding to a spoken voice command comprising a request for agricultural information;
transmitting the speech data from the mobile computing device to a voice service provider to cause the voice service provider to transform the speech data to a sequence of request text strings;
receiving, from the voice service provider, the sequence of request text strings comprising an intent string that indicates a category of the spoken voice command;
based on the sequence of request text strings, generating one or more queries for obtaining one or more result sets of agricultural data relevant to the category of the spoken voice command;
transmitting the one or more queries to one or more agricultural data repositories;
in response to transmitting the one or more queries to the one or more agricultural data repositories, receiving the one or more result sets of agricultural data from at least one of the one or more agricultural data repositories;
based on the one or more result sets, generating control signals for modifying controls implemented in an agricultural machine;
transmitting the control signals to the agricultural machine to cause modifying the controls implemented in the agricultural machine to control agricultural tasks performed by the agricultural machine.

2. The computer-implemented method of claim 1, further comprising:
transforming the one or more result sets of agricultural data into a sequence of response text strings;
generating digitized audio data based on the sequence of response text strings;
audibly playing the digitized audio data on one or more speaker devices.

3. The computer-implemented method of claim 1, further comprising:
requesting additional speech data;
receiving the additional speech data comprising one or more parameter clips;
transmitting the additional speech data from the mobile computing device to the voice service provider to cause the voice service provider to transform the additional speech data to one or more additional text strings;
receiving, from the voice service provider, the one or more additional text strings comprising one or more parameter values for the spoken voice command;
based on the one or more parameter values, generating one or more additional queries for obtaining one or more additional result sets of agricultural data relevant to the category of the spoken voice command;
transmitting the one or more additional queries to the one or more agricultural data repositories;
in response to transmitting the one or more additional queries to the one or more agricultural data repositories, receiving one or more additional agricultural data;
transforming the one or more additional agricultural data into an additional sequence of response text strings;
generating additional digitized audio data based on the additional sequence of response text strings;
audibly playing the additional digitized audio data on one or more speaker devices.

4. The computer-implemented method of claim 1, wherein the one or more result sets comprise information indicating one or more of: work prioritization information, field nutrients deficiency information, yield outcome information, weather notification information, planting recommendations, alerts, field identification data, field crop identification information or field soil characteristics information.

5. The computer-implemented method of claim 1, wherein the speech data is received via a conversational user interface;
wherein the conversational user interface is configured to receive audio input and generate audio output;
wherein the conversational user interface operates in a hands-free mode.

6. The computer-implemented method of claim 5, wherein the speech data is received as an audio recording started upon selecting a microphone icon displayed on the conversational user interface or a physical button implemented on a microphone, and ended upon deselecting the microphone icon displayed on the conversational user interface or the physical button implemented on the microphone.

7. The computer-implemented method of claim 1, further comprising;
prior to transmitting the speech data to the voice service provider:
determining a set of intents by analyzing a plurality of voice commands, each voice command of the plurality of voice commands related to the spoken voice command;
transmitting, from the mobile computing device to the voice service provider, the set of intents to cause the voice service provider to transform the speech data to an additional sequence of request text strings based on the spoken voice command and the plurality of voice commands.

8. One or more non-transitory computer-readable storage media storing instructions which, when executed using one or more processors, cause the one or more processors to perform:
receiving, at a mobile computing device, speech data of a spoken voice command comprising a request for agricultural information;
transmitting the speech data from the mobile computing device to a voice service provider to cause the voice service provider to transform the speech data to a sequence of request text strings;
receiving, from the voice service provider, the sequence of request text strings comprising an intent string that indicates a category of the spoken voice command;
based on the sequence of request text strings, generating one or more queries for obtaining one or more result sets of agricultural data relevant to the category of the spoken voice command;
transmitting the one or more queries to one or more agricultural data repositories;
in response to transmitting the one or more queries to the one or more agricultural data repositories, receiving the one or more result sets of agricultural data from at least one of the one or more agricultural data repositories;
based on the one or more result sets, generating control signals for modifying controls implemented in an agricultural machine;
transmitting the control signals to the agricultural machine to cause modifying the controls implemented in the agricultural machine to control agricultural tasks performed by the agricultural machine.

9. The one or more non-transitory computer-readable storage media of claim 8, storing additional instructions for:
transforming the one or more result sets of agricultural data into a sequence of response text strings;
generating digitized audio data based on the sequence of response text strings;
audibly playing the digitized audio data on one or more speaker devices.

10. The one or more non-transitory computer-readable storage media of claim 8, storing additional instructions for:
requesting additional speech data;
receiving the additional speech data comprising one or more parameter clips;
transmitting the additional speech data from the mobile computing device to the voice service provider to cause the voice service provider to transform the additional speech data to one or more additional text strings;
receiving, from the voice service provider, the one or more additional text strings comprising one or more parameter values for the spoken voice command;
based on the one or more parameter values, generating one or more additional queries for obtaining one or more additional result sets of agricultural data relevant to the category of the spoken voice command;
transmitting the one or more additional queries to the one or more agricultural data repositories;
in response to transmitting the one or more additional queries to the one or more agricultural data repositories, receiving one or more additional agricultural data;
transforming the one or more additional agricultural data into an additional sequence of response text strings;
generating additional digitized audio data based on the additional sequence of response text strings;
audibly playing the additional digitized audio data on one or more speaker devices.

11. The one or more non-transitory computer-readable storage media of claim 8, wherein the one or more result sets comprise information indicating one or more of: work prioritization information, field nutrients deficiency information, yield outcome information, weather notification information, planting recommendations, alerts, field identification data, field crop identification information or field soil characteristics information.

12. The one or more non-transitory computer-readable storage media of claim 8, wherein the speech data is received via a conversational user interface;
wherein the conversational user interface is configured to receive audio input and generate audio output;
wherein the conversational user interface operates in a hands-free mode.

13. The one or more non-transitory computer-readable storage media of claim 12, wherein the speech data is received as an audio recording started upon selecting a microphone icon displayed on the conversational user interface or a physical button implemented on a microphone, and ended upon deselecting the microphone icon displayed on the conversational user interface or the physical button implemented on the microphone.

14. The one or more non-transitory computer-readable storage media of claim 8, storing additional instructions for:
prior to transmitting the speech data to the voice service provider:
determining a set of intents by analyzing a plurality of voice commands, each voice command of the plurality of voice commands related to the spoken voice command;
transmitting, from the mobile computing device to the voice service provider, the set of intents to cause the voice service provider to transform the speech data to an additional sequence of request text strings based on the spoken voice command and the plurality of voice commands.

15. A computer system, comprising:
one or more memory units; and
a processor executing instructions stored in the one or more memory units to perform:
receiving, at a mobile computing device, speech data of a spoken voice command comprising a request for agricultural information;
transmitting the speech data from the mobile computing device to a voice service provider to cause the voice service provider to transform the speech data to a sequence of request text strings;
receiving, from the voice service provider, the sequence of request text strings comprising an intent string that indicates a category of the spoken voice command;
based on the sequence of request text strings, generating one or more queries for obtaining one or more result sets of agricultural data relevant to the category of the spoken voice command;
transmitting the one or more queries to one or more agricultural data repositories;
in response to transmitting the one or more queries to the one or more agricultural data repositories, receiving the one or more result sets of agricultural data from at least one of the one or more agricultural data repositories;
based on the one or more result sets, generating control signals for modifying controls implemented in an agricultural machine;
transmitting the control signals to the agricultural machine to cause modifying the controls implemented in the agricultural machine to control agricultural tasks performed by the agricultural machine.

16. The computer system of claim 15, wherein the processor executes additional instructions to perform:
transforming the one or more result sets of agricultural data into a sequence of response text strings;
generating digitized audio data based on the sequence of response text strings;
audibly playing the digitized audio data on one or more speaker devices.

17. The computer system of claim 15, wherein the processor executes additional instructions for:
requesting additional speech data;
receiving the additional speech data comprising one or more parameter clips;
transmitting the additional speech data from the mobile computing device to the voice service provider to cause the voice service provider to transform the additional speech data to one or more additional text strings;
receiving, from the voice service provider, the one or more additional text strings comprising one or more parameter values for the spoken voice command;
based on the one or more parameter values, generating one or more additional queries for obtaining one or more additional result sets of agricultural data relevant to the category of the spoken voice command;
transmitting the one or more additional queries to the one or more agricultural data repositories;
in response to transmitting the one or more additional queries to the one or more agricultural data repositories, receiving one or more additional agricultural data;
transforming the one or more additional agricultural data into an additional sequence of response text strings;
generating additional digitized audio data based on the additional sequence of response text strings;
audibly playing the additional digitized audio data on one or more speaker devices.

18. The computer system of claim 15, wherein the one or more result sets comprise information indicating one or more of: work prioritization information, field nutrients deficiency information, yield outcome information, weather notification information, planting recommendations, alerts, field identification data, field crop identification information or field soil characteristics information.

19. The computer system of claim 15, wherein the speech data is received via a conversational user interface;
wherein the conversational user interface is configured to receive audio input and generate audio output;
wherein the conversational user interface operates in a hands-free mode.

20. The computer system of claim 19, wherein the speech data is received as an audio recording started upon selecting a microphone icon displayed on the conversational user interface or a physical button implemented on a microphone, and ended upon deselecting the microphone icon displayed on the conversational user interface or the physical button implemented on the microphone.
